(19) United States
(12) Patent Application Publication
(10) Pub. No.: US 2026/0310134 A1
(43) Pub. Date: Oct. 8, 2026

(54) ELECTRONIC TIMEPIECE, DRIVE CONTROL METHOD, AND RECORDING MEDIUM

(71) Applicant: CASIO COMPUTER CO., LTD., Tokyo (JP)

(72) Inventor: Masanori ISHIHARA, Tokyo (JP)

(21) Appl. No.: 19/636,022

(22) Filed: Apr. 1, 2026

(30) Foreign Application Priority Data
Apr. 2, 2025 (JP) 2025-061080

(51) Int. Cl. G04C 3/14

(52) U.S. Cl. CPC G04C 3/14

(57) ABSTRACT

An electronic timepiece includes a hand, a driver, and a controller. The controller causes the hand to perform rotational operation for a number of plurality of times of unit operation at an interval of a unit time obtained by dividing the synchronization time by the number of times of unit operation, and in response to the interval of the rotational operation becoming greater than the unit time to cause a delay time during the rotational operation for the number of times of unit operation, the controller eliminates the delay time by setting, as respective intervals until at least two executions of unexecuted operation among a number of times of unexecuted operation before a first rotational operation in a next synchronization time, values obtained by distributing respective non-zero offset times corresponding to the delay time and adding the respective non-zero offset times to the unit time.

### CROSS-REFERENCE TO RELATED APPLICATION

This application is based upon and claims the benefit of priority from the prior Japanese Patent Application No. 2025-061080, filed on Apr. 2, 2025, the entire contents of which are incorporated herein by reference.

### BACKGROUND OF THE INVENTION

### TECHNICAL FIELD

The present disclosure relates to an electronic timepiece, a drive control method, and a recording medium.

### DESCRIPTION OF RELATED ART

In an electronic timepiece, there is a technique relating to sweep hand movement in which a second hand is operated at intervals shorter than one second so that movement of the hand appears smooth. In sweep hand movement, since the frequency of causing the hand to rotate is high, control for stably operating the hand while preventing power consumption from becoming excessively large is important. Japanese Unexamined Patent Application Publication No. 2013-122390 discloses a technique for an electronic timepiece capable of appropriately achieving both sweep hand movement and step hand movement while reducing power consumption.

### SUMMARY OF THE INVENTION

According to an aspect of the present disclosure, there is provided an electronic timepiece comprising a hand, a driver configured to cause the hand to perform rotational operation, and a controller configured to control an operation of the driver, wherein

the controller

causes, by the driver, for each synchronization time, the hand to perform rotational operation for a number of plurality of times of unit operation at an interval of a unit time obtained by dividing the synchronization time by the number of times of unit operation, and

in response to the interval of the rotational operation of the hand becoming greater than the unit time to cause a delay time during the rotational operation for the number of times of unit operation, the controller eliminates the delay time by setting, as respective intervals until at least two executions of unexecuted operation among a number of times of unexecuted operation before a first rotational operation in a next synchronization time, values obtained by distributing respective non-zero offset times corresponding to the delay time and adding the respective non-zero offset times to the unit time.

Further features of the present invention will become apparent from the following description of exemplary embodiments with reference to the attached drawings.

### BRIEF DESCRIPTION OF DRAWINGS

FIG. 1 is a block diagram illustrating a functional configuration of an electronic timepiece.

FIG. 2 is a diagram illustrating hand-movement timing.

FIG. 3A is a diagram illustrating an example of adjustment of a delay in hand-movement timing.

FIG. 3B is a diagram illustrating an example of adjustment of a delay in hand-movement timing.

FIG. 3C is a diagram illustrating an example of adjustment of a delay in hand-movement timing.

FIG. 4A is a diagram illustrating an example of adjustment of a delay in hand-movement timing.

FIG. 4B is a diagram illustrating an example of adjustment of a delay in hand-movement timing.

FIG. 5A is a diagram illustrating an example of adjustment of a delay in hand-movement timing.

FIG. 5B is a diagram illustrating an example of adjustment of a delay in hand-movement timing.

FIG. 6 is a flowchart illustrating a control procedure of second-synchronous interrupt control processing.

FIG. 7 is a flowchart illustrating a control procedure of interval timer interrupt processing.

FIG. 8 is a flowchart illustrating another example of the control procedure of interval timer interrupt processing.

FIG. 9 is a flowchart illustrating another example of the control procedure of interval timer interrupt processing.

FIG. 10 is a flowchart illustrating another example of the control procedure of interval timer interrupt processing.

FIG. 11 is a flowchart illustrating another example of the control procedure of interval timer interrupt processing.

FIG. 12 is a flowchart illustrating another example of the control procedure of interval timer interrupt processing.

### DETAILED DESCRIPTION

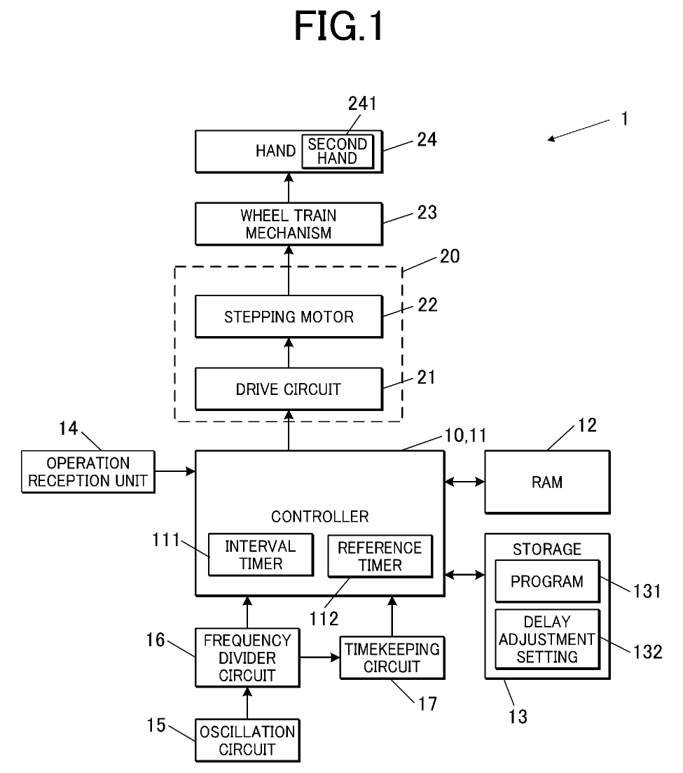

Embodiments will hereinafter be described with reference to the drawings. As illustrated in the block diagram of FIG. 1, an electronic timepiece 1 includes a controller 11, a RAM 12 (Random Access Memory), a storage 13, an operation reception unit 14, an oscillation circuit 15, a frequency divider circuit 16, a timekeeping circuit 17, a drive circuit 21, a stepping motor 22, a wheel train mechanism 23, a hand 24, and the like. The electronic timepiece 1 may be a portable electronic timepiece, such as a wristwatch.

The controller 11 has a processor that supervises the overall operation of the electronic timepiece 1. The processor may be a general-purpose CPU (Central Processing Unit), or may be a microcontroller dedicated to timepiece operation, an IC (Integrated Circuit), an LSI (Large-scale Integrated Circuit), or the like. The controller 11 may have a single processor, or may have a plurality of processors, each of which may independently perform processing operations according to the intended use or the like. Alternatively, the plurality of processors may cooperate to perform parallel processing. The controller 11 includes an interval timer 111 and a reference timer 112. The interval timer 111 and the reference timer 112 need not have dedicated hardware configurations, and the processor may simply count clock signals to calculate elapsed time. The interval timer 111 repeatedly counts a prescribed time from the timing of the second-synchronous signal and outputs an interrupt signal each time. This interrupt signal is hereinafter also referred to as a timer interrupt. The reference timer 112 counts elapsed time from on-the-second timing at which the fractional part of each second is zero. The controller 11 is included in the drive control apparatus 10 of the present embodiment.

The RAM 12 provides a working memory space to the controller 11 and stores temporary data. The RAM 12 stores data such as hand operation count data per second.

The storage 13 has a nonvolatile memory and stores a program 131 and setting data. The setting data includes a delay adjustment setting 132. The delay adjustment setting 132 stores hand-movement interval settings for eliminating a delay thereafter when hand movement for time display is delayed from scheduled timing. The nonvolatile memory may be, for example, a flash memory. Alternatively, the type is not particularly limited as long as it can be used as a nonvolatile memory.

The operation reception unit 14 receives an input operation from outside and outputs, to the controller 11, an operation signal corresponding to content of the received input operation. The operation reception unit 14 may include, for example, a push-button switch. The operation reception unit 14 may also include a crown, a slide switch, and/or another operating mechanism.

The oscillation circuit 15 includes, for example, a quartz crystal resonator and a resonance circuit, and generates a clock signal near the resonance frequency of the quartz crystal resonator. The resonance frequency may be, for example, 32.768 kHz or 16.384 kHz. This resonance frequency varies not only depending on the adjustment accuracy of the quartz crystal resonator but also depending on environmental conditions such as temperature. The quartz crystal resonator may be an AT-cut resonator that is stable near room temperature with respect to temperature changes. The frequency divider circuit 16 divides the clock signal into a signal having an appropriate frequency and outputs the divided signal. The divided signal may have any of a plurality of frequencies, and the frequency may be determined according to the frequency required by each part of the electronic timepiece 1. The divided frequencies may include a 1 Hz signal for counting date and time, that is, a signal having a cycle of 1 second (reference time). The frequency divider circuit 16 may include a logic pacing circuit. The logic pacing circuit can appropriately decimate or add the 1 Hz signal in accordance with a minute deviation of the 1 Hz signal.

The timekeeping circuit 17 may count the 1 Hz signal and obtain the current time and date, that is, date and time, in units of 1 second (reference time). The operation of the timekeeping circuit 17 may be included in a software operation of the controller 11. That is, the electronic timepiece 1 need not have the timekeeping circuit 17 as a hardware configuration. Alternatively, separately from the operation of the controller 11 as the timekeeping circuit 17, the electronic timepiece 1 may have a real-time clock (RTC) as a hardware configuration.

The drive circuit 21 outputs a drive signal for the stepping motor 22 based on control by the controller 11. The stepping motor 22 performs rotational operation by a prescribed angle in accordance with the input drive signal. The stepping motor 22 includes a rotation detection unit 221 and can detect whether rotation has occurred by, for example, identifying a position of a rotor relative to a stator by a rotor position detection mechanism. The wheel train mechanism 23 is a gear train that converts rotation of the stepping motor 22 into rotation of the hand 24. The hand 24 is a needle-like body used for displaying time and performs rotational operation, within a plane along the display surface of the electronic timepiece 1, in accordance with operation of the wheel train mechanism 23, that is, operation of the stepping motor 22. The hand 24 may include a second hand 241, a minute hand, and an hour hand. The hand 24 may include other hands in addition to the second hand 241, the minute hand, and the hour hand. The other hands may have rotation shafts at positions different from those of the second hand 241, the minute hand, and the hour hand. The drive circuit 21 and the stepping motor 22 correspond to the driver 20 of the present embodiment.

Next, rotational operation of the hand 24 in the electronic timepiece 1 including the drive control method of the present embodiment will be described. In the electronic timepiece 1, time is displayed by rotation of the second hand 241, the minute hand, and the hour hand as described above. At least the second hand 241 performs rotational operation independently of the other hands. The second hand 241, the minute hand, and the hour hand may each be driven to perform rotational operation independently by a separate stepping motor 22 and wheel train mechanism 23. Alternatively, the minute hand and the hour hand may rotate in conjunction with each other. That is, the electronic timepiece 1 may have the wheel train mechanism 23 that rotates the hour hand at a rotation angle that is 1/12 of rotation of the minute hand in response to operation of a common stepping motor 22.

The second hand 241 of the electronic timepiece 1, in displaying time, performs rotational operation at intervals shorter than 1 second (the synchronization time) and makes one revolution within the display surface in 1 minute. A normal second hand 241 that performs rotational operation every second rotates by 6 degrees at a time. In contrast, the second hand 241 of the present embodiment may rotate, in one rotational operation, by an angle obtained by dividing 6 degrees into 12, that is, by 0.5 degrees (a unit angle) at a time. That is, the unit angle through which the second hand 241 rotates in one operation is 0.5 degrees, and the second hand 241 need only perform rotational operation 12 times (the number of times of unit operation) every second at intervals of approximately 1/12 second (the unit time), obtained by dividing the synchronization time into a plurality of portions. Such rotational operation at fine, substantially equal intervals is visually close to smooth rotation for a user and is also referred to as sweep hand movement. In the present disclosure, the hand caused to perform rotational operation for each unit time means the second hand 241, but the electronic timepiece 1 may have another hand that performs operation at intervals of less than 1 second similarly to the second hand 241. The minute hand and the hour hand may operate in a conventional manner. For example, the minute hand may perform rotational operation by 1 degree once every 10 seconds, and the hour hand may perform rotational operation by 1 degree once every 2 minutes.

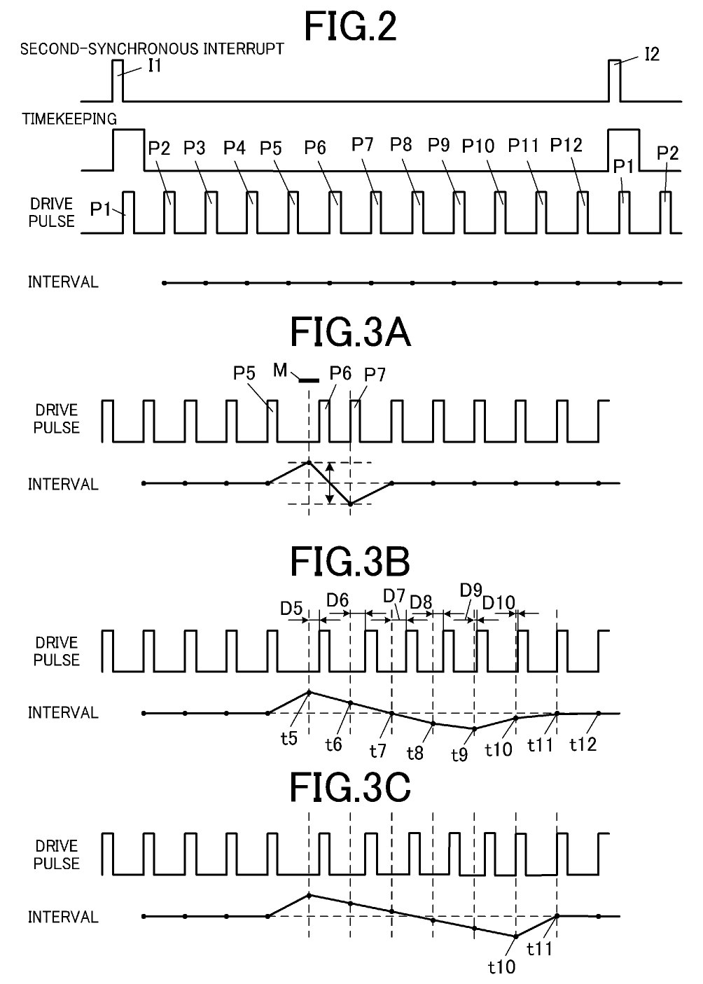

As illustrated in FIG. 2, in the electronic timepiece 1, a second-synchronous signal synchronized with on-the-second timing at which the fractional part of each second is zero is output by interrupt from the timekeeping circuit 17 to the controller 11. This interrupt is hereinafter also referred to as a second-synchronous interrupt. In response to the second-synchronous interrupts I1, I2, and the like, counting of time and output of a drive pulse P1, which is a drive signal for causing the hand to operate, are performed as timekeeping processing. In addition to the drive pulse P1, the electronic timepiece 1 of the present embodiment defines output timings of drive pulses P2 to P12 relating to rotational operations other than the second-synchronous timing by repeatedly measuring a timer for a unit drive interval within each second. This counting of the unit drive interval is performed by the interval timer 111. That is, in the electronic timepiece 1, the output frequency of the synchronization signal with time is not increased in accordance with the number of times of operation (the number of times of unit operation) of the second hand 241. The interval timer 111 counts the unit drive interval for 11 hand operations for each of the second-synchronous interrupts I1 and I2 and outputs an interrupt signal each time.

However, the control operation performed by the controller 11 of the electronic timepiece 1 is not limited to hand-movement operation. While the second hand 241 is being caused to perform rotational operation for the number of times of unit operation in each second, an interrupt operation for other processing may be performed. At this time, execution of processing for outputting a control signal to the driver 20 is delayed until the other processing is completed, and hand-movement timing may be delayed such that an interval from previous hand movement becomes longer than the original unit time. As illustrated in FIG. 3A, when the drive pulse P6 is delayed by the interrupt operation M, an interval between the drive pulses P5 and P6 becomes longer than usual. If the next drive pulse P7 is output at the original timing, an interval between the drive pulses P6 and P7 becomes shorter than usual. That is, the interval of the drive pulses changes greatly between P5 and P6 and between P6 and P7. Such hand-movement operation becomes unnatural as sweep hand movement.

In the electronic timepiece 1 of the present embodiment, for example, as illustrated in FIG. 3B, when output of a drive pulse is delayed, output timing of subsequent drive pulses is not immediately returned to the original timing. In this case, the delay is eliminated by distributing, as non-zero offset times (addition times) corresponding in total to the delay time, to intervals until output of a plurality of, that is, at least two, drive pulses among the number of times of drive pulse that have not yet been output (the number of times of unexecuted operation) before the first drive pulse P1 accompanying the next second synchronization. The plurality of distributions is performed so that a change in interval between adjacent drive pulses does not become abrupt. Since the drive pulse P1 at each on-the-second timing is separately controlled by the second-synchronous interrupt, elimination of the delay is completed by the on-the-second timing at the latest. However, depending on the timing of the drive pulse P12 in the previous synchronization time, the interval between the drive pulses P12 and P1 may be changed and adjusted from the unit time.

In the example of FIG. 3B, when the interval t5 between the drive pulses P5 and P6 becomes longer and a delay time D5 occurs relative to the original timing, the interval t6 between the next drive pulses P6 and P7 is determined by adding, to the unit drive interval, a time shorter than the delay time D5. In each subsequent interval t7 to t9, the addition time sequentially decreases and further becomes a negative value, whereby the delay time proceeds toward reduction with the delay time D7 as a local maximum. After the delay time D9 approaches zero, in the intervals t10 to t11, the addition time is caused to asymptotically approach zero while the delay time is also caused to converge to zero. As a result, since no abrupt change occurs during the intervals t5 to t12, the hand-movement timing can be returned to normal while reducing unnaturalness of the hand-movement operation. That is, the addition times for the plurality of intervals may include both positive and negative values.

Alternatively, as illustrated in FIG. 3C, the change in the addition time in each interval may be uniform, and the addition time need not asymptotically approach zero at the end. That is, the addition times for the plurality of intervals may monotonically decrease from a positive value to a negative value. In this case, the change between the interval t10 and the interval t11 becomes greater than in the example of FIG. 3B described above, but does not become so large that the sign (positive/negative) reverses across the unit drive interval.

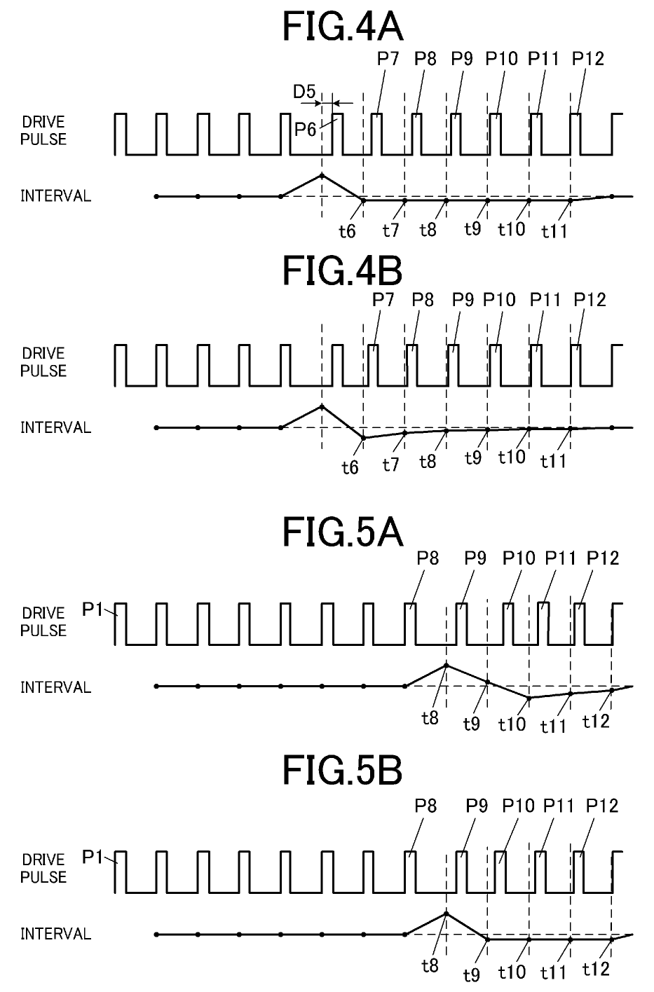

In the examples of FIGS. 3B and 3C, after the delay of the first drive pulse, the delay time further increases once. Such an increase may be undesirable, or there may be no time available for causing such an increase. In this case, all of the addition times may be negative values. For example, as in FIG. 4A, the delay time D5 generated at the drive pulse P6 may be eliminated by uniformly shortening the intervals t6 to t11. That is, the addition times for hand-movement intervals relating to output of a plurality of drive pulses P7 to P12 need only be negative fixed values. In this case, the change between the intervals t5 and t6 occurs across positive and negative values, but the amount of shortening of the interval t6 is smaller than in the case illustrated in FIG. 3A. The interval t12 after the drive pulse P12 need not be counted because it is appropriately determined relative to the next drive pulse P1 determined in accordance with the second-synchronous interrupt I2. The timing of the drive pulseP12 need only be appropriately adjusted so that the remaining delay time and an adjustment amount for the fractional time, that is, the addition time, resultantly fall within an appropriate range.

Alternatively, as illustrated in FIG. 4B, with respect to the delay time D5 generated at the drive pulse P6, the intervals t6 to t11 shortened by the drive pulses P7 to P12 and the like need not be uniform. Here, the addition times relative to the unit drive time in the intervals t6 to t11 may monotonically increase so as to be negative values and converge to zero. Thereby, both the delay time and the drive interval approach correct values toward the next on-the-second timing. In this case, the change between the intervals t5 and t6 becomes even greater than in the case of FIG. 4A. To prevent this from becoming excessively large, the timing of the drive pulse P7 may be determined so that the absolute value of the addition time is equal to or less than a predetermined upper limit relative to the delay time at the drive pulse P6, for example, 50% or less.

These changes depend on at which occurrence among the number of times of unit operation the output delay of the drive pulse has occurred, that is, on the number of times of unexecuted operation among the number of times of unit operation. That is, as illustrated in FIG. 5A, when a delay occurs in the ninth drive pulse P9, the number of drive pulses whose timing can be adjusted to eliminate the delay time is three, namely the drive pulses P10 to P12. Accordingly, even in the variation pattern illustrated in FIG. 3B above, the amount of change in each of the intervals t9 to t11 becomes relatively large. Similarly, as illustrated in FIG. 5B, compared with the example illustrated in FIG. 4A, the addition times for the intervals t9 to t12 become larger because the number of times is smaller. When a delay occurs in the drive pulse P12, however, no adjustment is possible, and adjustment is therefore performed at one time by the next drive pulse P1. In this case, unnatural operation is unavoidable, but misalignment of the position of the second hand 241 at the on-the-second timing can be avoided.

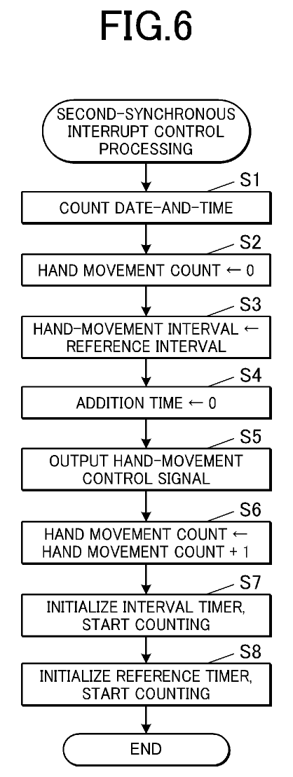

When the second-synchronous interrupt occurs, the controller 11 performs interrupt control as illustrated in FIG. 6. The controller 11 performs counting by adding 1 second to the current date and time (S1). The controller 11 sets the number of times of hand movement in the second to zero (S2). The controller 11 sets a reference interval preset as the hand-movement interval (S3). The reference interval need not be exactly 1/12 second. The reference interval only needs to be about 83.3 milliseconds within a range in which it is difficult for a user to visually recognize that an interval from the twelfth hand movement to the first hand movement in the next second differs from the reference interval. The controller 11 sets the addition time to zero (S4).

The controller 11 outputs, to the drive circuit 21, a control signal for causing the stepping motor 22 to perform rotational operation (S5). The controller 11 adds 1 to the number of times of hand movement (S6). The controller 11 may omit step S2 and set the number of times of hand movement to 1 in step S6. The controller 11 initializes the interval timer 111 and starts counting the hand-movement interval (S7). The controller 11 initializes the reference timer and starts counting elapsed time from the on-the-second timing (S8). The controller 11 then ends the second-synchronous interrupt control processing.

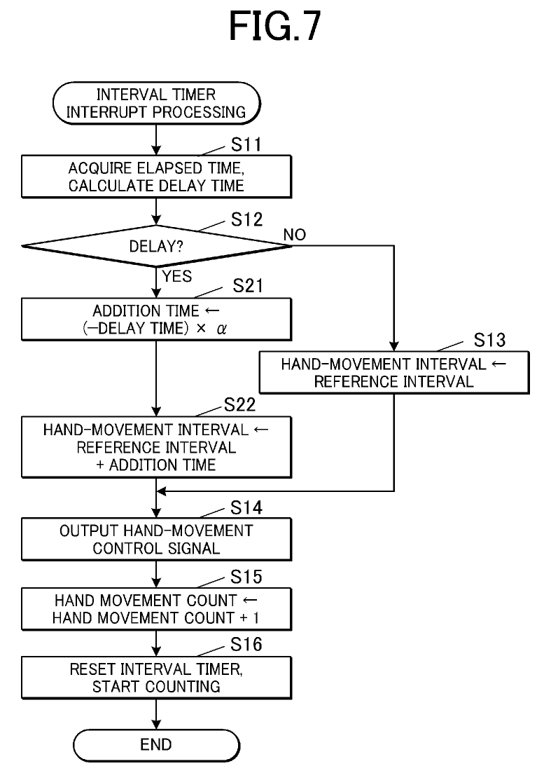

When the hand-movement interval is counted by the interval timer 111 and an interrupt of the interval timer occurs, interval timer interrupt processing is executed. As described above, when another interrupt processing is being executed, execution of the interrupt of the interval timer is placed on standby until the interrupt processing ends. In the interval timer interrupt processing, for example, as illustrated in FIG. 7, the controller 11 acquires elapsed time counted by the reference timer 112 (S11). The controller 11 determines whether the acquired elapsed time is delayed relative to the present hand-movement timing (S12). When it is determined that there is no delay (S12; NO), the controller 11 sets the reference interval as the hand-movement interval (S13). The processing of the controller 11 then proceeds to step S14.

When it is determined that there is a delay (S12; YES), the controller 11 sets, as the addition time, a value obtained by multiplying, by a coefficient α, a negative value obtained by reversing a sign of the delay time (S21). The coefficient α may be, for example, 0.5. The controller 11 sets, as the hand-movement interval, a value obtained by adding the addition time to the reference interval (S22). The processing of the controller 11 then proceeds to step S14.

In step S14, the controller 11 outputs, to the drive circuit 21, a hand-movement control signal for causing the stepping motor 22 to perform rotational operation (S14). The controller 11 adds 1 to the number of times of hand movement (S15). The controller 11 resets the interval timer 111 and causes the interval timer 111 to start counting (S16). The controller 11 then ends the interval timer interrupt processing.

In this processing, when a delay time occurs, half of the delay time at that time is eliminated for each hand movement. Accordingly, the delay is eliminated in the pattern of FIG. 4B, in which the delay time and the addition time are halved each time and asymptotically approach zero.

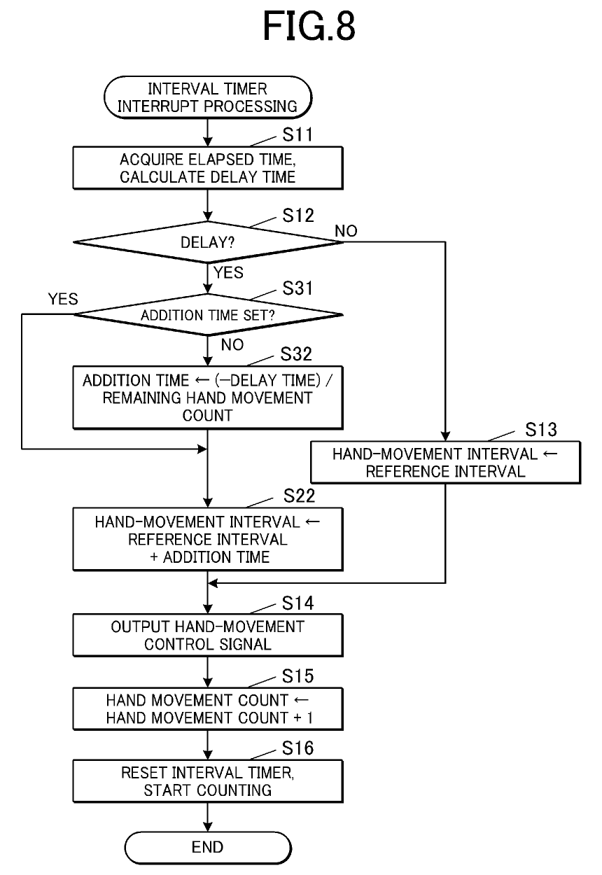

Alternatively, the interval timer interrupt processing may be executed according to the procedure illustrated in FIG. 8. Compared with the processing illustrated in FIG. 7, in the interval timer interrupt processing of FIG. 8, steps S31 and S32 are executed instead of step S21. The other processing contents are the same, and the same reference signs are applied to steps having the same processing contents, and detailed description thereof is omitted.

When it is determined in step S12 that there is a delay (S12; YES), the controller 11 determines whether the addition time has been set (S31). When it is determined that the addition time has not been set (S31; NO), the controller 11 determines, as the addition time, a value obtained by dividing a negative value obtained by reversing a sign of the delay time by the remaining number of times of hand movement (S32). The processing of the controller 11 then proceeds to step S22. When it is determined that the addition time has been set (S31; YES), the processing of the controller 11 proceeds to step S22.

In the processing illustrated in FIG. 8, the addition time when a delay occurs is a fixed value determined according to the magnitude of the delay time and the remaining number of times of hand movement. Accordingly, as illustrated in FIGS. 4A and 5B, the delay time is eliminated at an equal rate during the remaining hand movements.

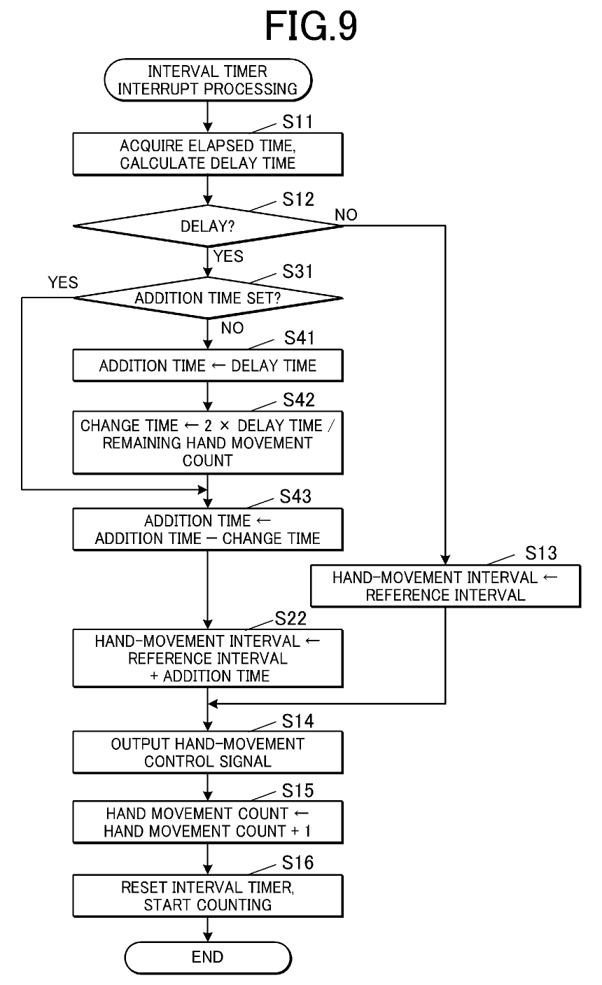

Alternatively, the interval timer interrupt processing may be executed according to the procedure illustrated in FIG. 9. Compared with the processing illustrated in FIG. 8, in the interval timer interrupt processing of FIG. 9, steps S41 to S43 are executed instead of step S32. The other processing contents are the same, and the same reference signs are applied to steps having the same processing contents, and detailed description thereof is omitted.

When it is determined that the addition time has not been set (S31; NO), the controller 11 sets the delay time as an initial value of the addition time (S41). The controller 11 sets, as a change time, a value obtained by dividing twice the delay time by the remaining number of times of hand movement (S42). The processing of the controller 11 then proceeds to step S43. When it is determined in step S31 that the addition time has been set (S31; YES), the processing of the controller 11 proceeds to step S43.

In step S43, the controller 11 subtracts the change time from the setting value of the addition time (S43). That is, the addition time, that is the hand-movement interval decreases from the delay time at a constant interval and changes from a positive value to a negative value, and the delay time is finally eliminated. Accordingly, as illustrated in FIG. 3C, the delay time is uniformly eliminated while increasing once, without causing a large change in the hand-movement interval.

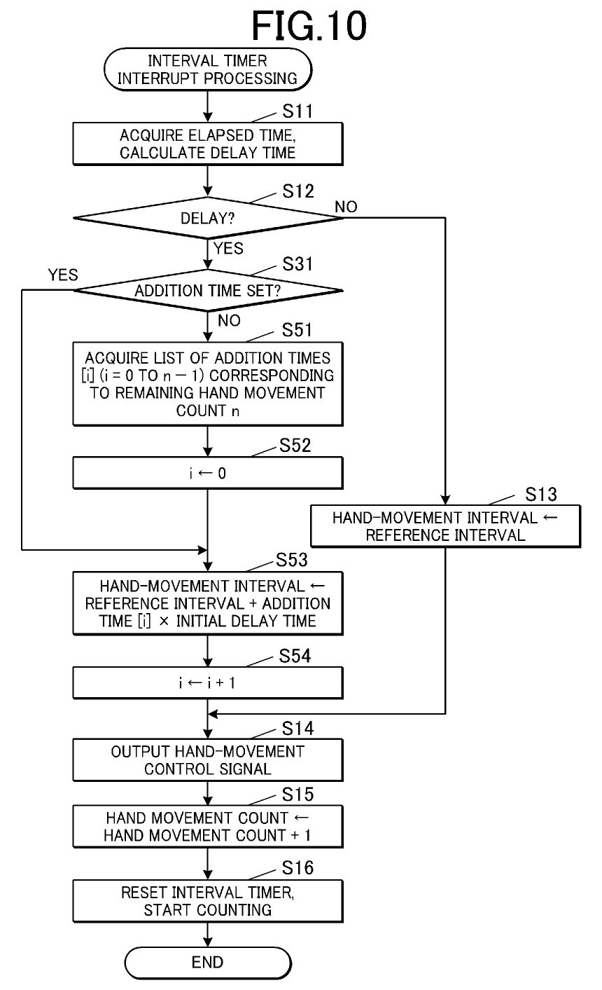

Alternatively, the interval timer interrupt processing may be executed according to the procedure illustrated in FIG. 10. Compared with the processing illustrated in FIG. 8, in the interval timer interrupt processing of FIG. 10, steps S51 to S54 are executed instead of step S32. The other processing contents are the same, and the same reference signs are applied to steps having the same processing contents, and detailed description thereof is omitted. In this interval timer interrupt processing, the delay adjustment setting 132 (the storage) stores and holds in advance, for each number of times of unexecuted operation, a variation pattern of normalized addition times (unit addition times) at respective hand-movement timings. That is, a sum of the unit addition times may be “-1”. However, when adjustment of the delay time is also performed in the interval t12 after the twelfth drive pulse P12 and before the next drive pulse P1, the sum of the unit addition times may deviate from “-1” by an amount corresponding to the adjustment. The remaining number of times of hand movement may be 1 or more and 10 or less. In each variation pattern, that is, even when the only adjustable drive pulse is the drive pulse P12, the interval t12 is also adjusted by adjustment of the interval t11 until the drive pulse P12 is output.

When it is determined in step S31 that the addition time has not been set (S31; NO), the controller 11 refers to the delay adjustment setting 132 and acquires a variation pattern of unit addition times corresponding to the remaining number of times of hand movement n (S51). The controller 11 sets a variable i to zero (S52). The processing of the controller 11 then proceeds to step S53. When it is determined that the addition time has been set (S31; YES), the processing of the controller 11 proceeds to step S53.

In step S53, the controller 11 adds, to the reference interval, a value obtained by multiplying the i-th unit addition time by the initial delay time and sets a resultant value as the present hand-movement interval (S53). The controller 11 adds 1 to the variable i (S54). The processing of the controller 11 then proceeds to step S14.

By storing the variation pattern of the unit addition times in the delay adjustment setting 132 in this manner, the variation pattern can be set arbitrarily. That is, this interval timer interrupt processing is effective in complex cases, such as where the variation pattern is a quadratic function or a higher-order function, where the variation pattern is nonlinear, or where a plurality of variation patterns are combined. Accordingly, this interval timer interrupt processing can be particularly effectively used for the variation pattern illustrated in FIG. 3B and the like and the variation pattern illustrated in FIG. 5A and the like.

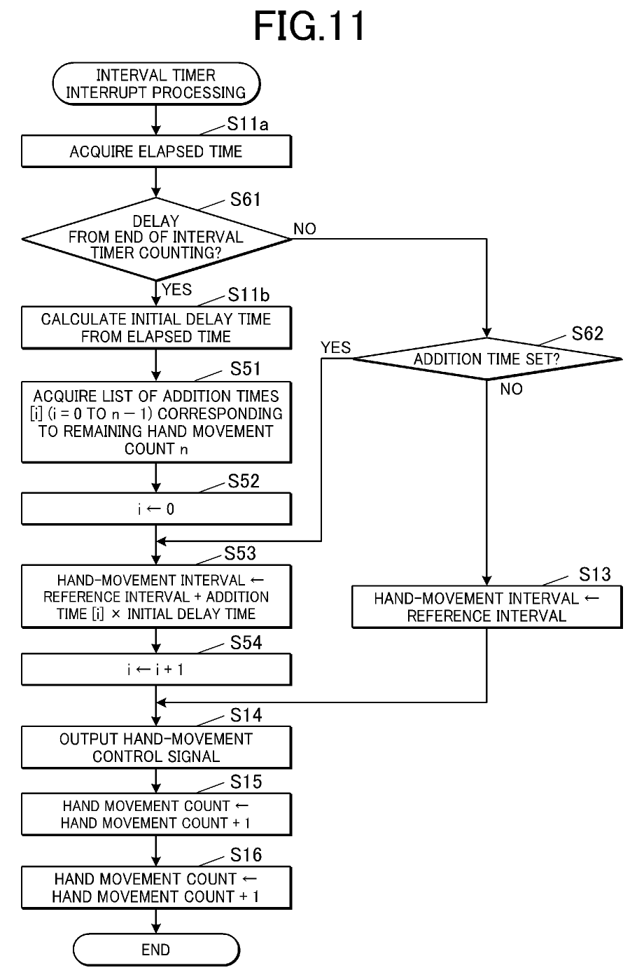

In the above description, a delay is assumed to occur only once in each second, but a delay may occur two or more times. To support two or more delays, as illustrated in FIG. 11, step S61 may be executed instead of step S12, and step S31 may be moved and positioned as step S62. Step S11 is also divided into steps S11a and S11b. Here, as one embodiment, the other processing is the same as the interval timer interrupt processing illustrated in FIG. 10. However, as another embodiment, the other processing may be any of the processing illustrated in FIGS. 7 to 9.

When the interval timer interrupt processing is started, the controller 11 acquires elapsed time (S11a). Based on the acquired elapsed time, the controller 11 determines whether there is a time difference between a counting-end timing by the interval timer 111 and a start of execution of the interval timer interrupt processing (S61). That is, the controller 11 determines whether a delay has occurred from a time at which the interval timer interrupt processing was originally scheduled to start based on the interval timer 111 until an actual start. When it is determined that there is a time difference (S61; YES), the controller 11 calculates, based on the elapsed time acquired in step S11a, an initial delay time from a hand-movement timing in an originally non-delayed state (S11b). The processing of the controller 11 then proceeds to step S51.

When it is determined that there is no time difference between the counting-end timing of the interval timer 111 and the start of execution of the interval timer interrupt processing (S61; NO), the controller 11 determines whether the addition time has been set (S62). When it is determined that the addition time has not been set (S62; NO), the processing of the controller 11 proceeds to step S13. When it is determined that the addition time has been set (S62; YES), the processing of the controller 11 proceeds to step S53.

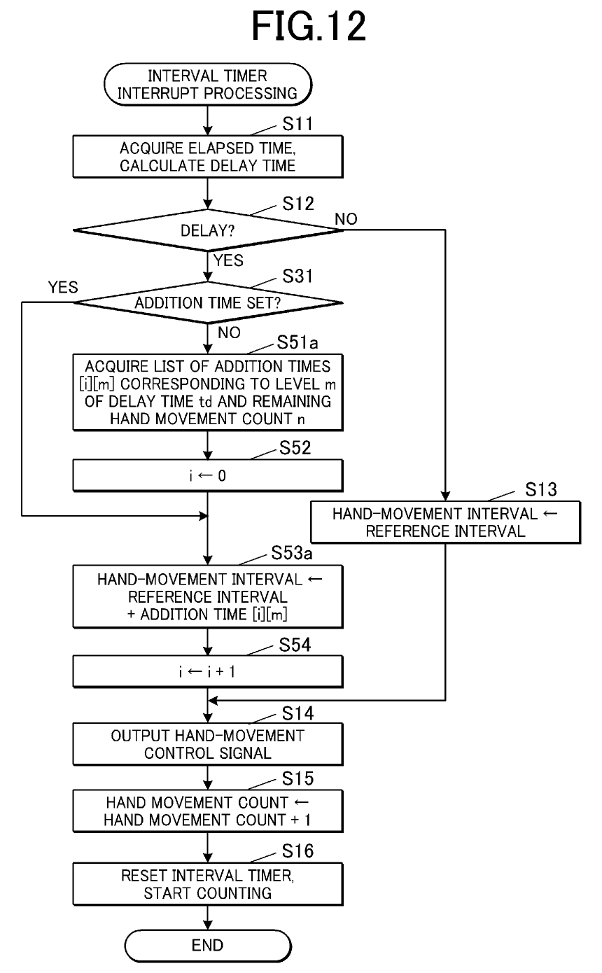

On the other hand, instead of the variation pattern of unit addition times corresponding to the remaining number of times of hand movement n, the delay adjustment setting 132 may store a variation pattern of addition times corresponding to the remaining number of times of hand movement n and the delay time td. A level m may be defined at intervals, such as 5 to 10 milliseconds, within a range in which the rotational-operation interval of the second hand 241 does not change greatly in accordance with the delay time td. That is, the level m may be a value obtained by removing a remainder from a quotient obtained by dividing the delay time td by a predetermined interval. In the interval timer interrupt processing illustrated in FIG. 12, steps S51 and S53 of the interval timer interrupt processing illustrated in FIG. 10 are changed to steps S51a and S53a, respectively. The other processing contents are the same, and the same reference signs are assigned to the same steps, and detailed description thereof is omitted.

When the determination in step S31 is NO, the controller 11 acquires a list of addition times [i][m] (0≤i≤n−1) corresponding to the remaining number of times of hand movement n and the level m of the delay time td (S51a). The controller sets a variable i to zero (S52). The controller 11 sets, as the hand-movement interval, a value obtained by adding the addition time [i][m] to the reference interval (S53a). The processing of the controller 11 then proceeds to step S54.

As described above, the drive control apparatus 10 of the present embodiment includes the controller 11. The controller 11 controls operation of the driver 20 that causes the second hand 241 to perform rotational operation. The controller 11 outputs, to the driver 20, a control signal for causing the second hand 241 to perform rotational operation for the number of times of unit operation at intervals of a unit time obtained by dividing a synchronization time, here 1 second, into the plurality of number of times of unit operation. When a delay time occurs during the rotational operation for the number of times of unit operation such that an interval of the rotational operation of the second hand 241 becomes greater than the unit time, the controller 11 eliminates the delay time by setting, as respective intervals until at least two executions among the number of times of unexecuted operation before a first rotational operation in a next synchronization time are performed, values obtained by distributing respective non-zero offset times corresponding to the delay time and adding the respective non-zero offset times to the unit time. That is, when a delay occurs in hand operation, the delay is handled not by attempting to eliminate it at one time but by dividing the delay over timings of a plurality of hand operations. Thereby, the operating interval of the second hand 241 is less likely to change abruptly, and a user is less likely to feel unnaturalness in rotation of the second hand 241. On the other hand, since the delay is eliminated by the next second synchronization, the second hand 241 does not continue to point to an inaccurate position, and can promptly return to normal hand-movement operation. According to the electronic apparatus disclosed inJapanese Unexamined Patent Application Publication No. 2013-122390 described above,there are other processes to be executed in addition to hand-movement processing synchronized with passage of time, and such other processing may delay the hand-movement processing; if the hand-movement delay were left unresolved indefinitely, an inaccurate display state would continue, resulting in poor usability. In contrast, according to the drive control apparatus 10 of the present disclosure, and the electronic timepiece 1 including the drive control apparatus 10 and the second hand 241, usability for a user relating to hand-movement display synchronized with passage of time can be improved. The distribution referred to herein means a planned adjustment in which the addition time is dispersed even when the delay can actually be eliminated at one time. That is, the distribution does not mean an adjustment in which, when the delay cannot in principle be eliminated by a single hand operation according to an operation limit of the stepping motor 22 or the magnitude of the delay, a delay time that could not be completely eliminated is eliminated by subsequent hand operations. Accordingly, at least the first of the distributed addition times has an absolute value smaller than the delay time and smaller than a maximum value that can be set in each rotational operation.

The offset times may also include both positive values and negative values. That is, in the electronic timepiece 1, a hand-movement interval that temporarily further increases the hand-movement delay may also be set. If an attempt is made to immediately reduce the delay from a state in which the hand-movement interval has widened and hand movement has been delayed, the hand-movement interval becomes narrower than the original interval. Accordingly, the change in the hand-movement interval between occurrence of the delay and elimination of the delay tends to become large. Even when adjustment is made in a direction that temporarily increases the delay, unnatural hand movement can be reduced by gradually narrowing the hand-movement interval.

The offset times may monotonically decrease from a positive time shorter than the delay time to a negative time. That is, with this setting, since an amount of change in the hand-movement interval at each time does not become large, unnatural operation of the second hand 241 is reduced, and the hand-movement delay is eliminated by orderly operation.

On the other hand, the offset times may be negative values. That is, by not setting an offset time that further increases the delay, a total amount of delay elimination can be minimized. By distributing this over a plurality of times, an amount of delay elimination per time, that is, an amount of shortening of the hand-movement interval, can be kept small. Accordingly, the electronic timepiece 1 can make it less likely that unnaturally fast operation of the second hand 241 will occur.

The offset times may also be negative values that asymptotically approach zero. As an operating interval of the second hand 241 gradually approaches a normal interval, the electronic timepiece 1 can smoothly transition to normal hand movement after elimination of the delay.

The offset times may also be fixed values. By making an amount of delay elimination constant each time, the hand-movement interval during elimination of the delay becomes constant, and an amount of decrease in the hand-movement interval per time becomes small. That is, even when a delay occurs in hand-movement timing, the electronic timepiece 1 can keep deviation and variation of the hand-movement interval from a normal interval small.

The drive control apparatus 10 may also include the storage 13, in which the delay adjustment setting 132 is stored. The delay adjustment setting 132 may store, for each number of times of unexecuted operation, a variation pattern obtained by normalizing offset times for the number of times of unexecuted operation. The controller 11 may set the respective offset times for the number of times of unexecuted operation by multiplying an initial delay time when the delay time occurs by the respective normalized offset times included in the variation pattern. By defining such a variation pattern as a table, it becomes possible to freely define a complex variation pattern of the hand-movement intervals that is difficult to obtain by a calculation formula or the like. In particular, when the variation pattern is approximated by a curve, by appropriately determining the intervals in advance, it becomes possible to eliminate the delay smoothly with less visual unnaturalness.

Alternatively, the drive control apparatus 10 may include the storage 13 including the delay adjustment setting 132 that stores setting values relating to intervals. When the delay time occurs, the controller 11 may read out from the storage 13 the setting values corresponding to the delay time and the number of times of unexecuted operation, and may set the respective offset times for the number of times of unexecuted operation. In this manner, by the delay adjustment setting 132 storing a variation pattern of the offset times for combinations of the number of times of unexecuted operation and the delay time, the drive control apparatus 10 and the electronic timepiece 1 including the drive control apparatus 10 can set each hand-movement interval with a small amount of computation and can easily cause hand-movement operation to be performed even with a particularly complex variation pattern of the hand-movement intervals.

The electronic timepiece 1 of the present embodiment includes the drive control apparatus 10, the second hand 241, and the driver 20. The second hand 241 rotates by a unit angle corresponding to a unit time obtained by dividing 1 second into the plurality of number of times of unit operation. The driver 20 causes the second hand 241 to perform rotational operation. According to the electronic timepiece 1, when a delay of hand-movement operation occurring during hand movement of the second hand 241, particularly hand movement at short intervals such as sweep hand movement, is to be promptly eliminated, unnaturalness occurring in operation of the second hand 241 can be reduced. Thereby, the electronic timepiece 1 can promptly eliminate the hand-movement delay while reducing a user’s sense of discomfort. Accordingly, an easy-to-use electronic timepiece 1 can be obtained.

The drive control method of the present embodiment is a drive control method relating to operation of the driver 20 that causes the second hand 241, which rotates by a unit angle corresponding to a unit time obtained by dividing 1 second into the plurality of number of times of unit operation, to perform rotational operation. In this drive control method, the driver 20 causes the second hand 241 to perform rotational operation for the number of times of unit operation every second at intervals of the unit time. When a delay time occurs during the rotational operation for the number of times of unit operation such that an interval of the rotational operation of the second hand 241 becomes greater than the unit time, the delay time is eliminated by setting, as respective intervals until at least two executions among a number of times of unexecuted operation in 1 second during which the hand has not been caused to perform rotational operation are performed, values obtained by distributing respective non-zero offset times corresponding to the delay time and adding the respective non-zero offset times to the unit time. According to such a drive control method, even when a delay occurs in hand movement due to other processing or the like during fine hand movement shorter than one second, the delay can be promptly eliminated while reducing unnaturalness. According to this drive control method, the hand-movement delay can be promptly eliminated while reducing a user’s sense of discomfort. Accordingly, usability for a user relating to hand-movement display can be improved.

The above embodiment is merely illustrative, and various modifications are possible. For example, in the above description, the magnitude of the addition time per occurrence is changed according to the number of times of unexecuted operation when a delay occurs, but the present disclosure is not limited thereto. The plurality of variation patterns themselves may be changed and set according to the number of times of unexecuted operation. For example, when the number of times of unexecuted operation is equal to or greater than a reference number, an example in which the addition time changes between positive and negative values may be used as the variation pattern, and when the number of times of unexecuted operation is smaller than the reference number, an example in which all of the addition times are negative may be used as the variation pattern.

In the above description, the negative addition time is added to the reference interval, but the addition time may instead be subtracted from the reference interval. Instead of obtaining the addition time by reversing the sign (positive/negative) of the delay time, the coefficient α may be a negative value.

Further, detection of a delay at each hand-movement timing and/or calculation of the delay time need not be based on the interval timer 111 and the reference timer 112. The delay time may be obtained by another method. For example, the delay time may be counted directly. Further, the timer measurement is not limited to an operation performed by the controller 11 under software control. The timer measurement may be performed by a hardware configuration. The hardware configuration may be, for example, a flip-flop circuit or the like.

Further, the number of times of unit operation is not limited to 12, and accordingly the unit time need not be 1/12 second. The number of times of unit operation need only fall within a range that makes it possible, when a delay occurs, to distribute elimination of the delay over a plurality of hand-movement operations so as to reduce a change in the hand-movement interval. Further, the second-synchronous signal need not be in units of 1 second. For example, the second-synchronous signal may be in units of 0.5 second or may be in units of 2 seconds. Further, in this rotational operation, the intervals t1 to t11 may be slightly different from the interval t12 depending on counting accuracy of the interval timer 111. In this case, an initial value of the interval t12 is regarded as the reference interval.

Further, the variation pattern of the hand-movement interval, that is, the variation pattern of the addition time, is not limited to the exemplified patterns described above. Any variation pattern may be set as long as the addition time does not change greatly at one time.

Further, in the above description, the timing of hand-movement operation at a next second synchronization is returned to normal regardless of the number of times of unexecuted operation, but the present disclosure is not limited thereto. For example, a lower-limit number may be set to 3, and when the number of times of unexecuted operation is smaller than the lower-limit number, ordinary hand-movement delay elimination may be abandoned and sweep hand movement in the next second may be stopped so as to advance the hand to a position one second ahead. That is, when unnatural hand-movement operation is unavoidable, the electronic timepiece 1 may be controlled so as to interrupt hand movement once and resume hand movement from an appropriate timing and position.

Further, when the number of times of unexecuted operation is equal to or greater than an upper-limit number, the variation pattern of the addition time may be defined such that the hand-movement delay is eliminated in a fixed upper-limit number of occurrences. For example, when the upper-limit number is 8 and a delay occurs in the drive pulse P2 or the drive pulse P3, hand movement may be returned to normal by the drive pulse P10 or the drive pulse P11.

Further, in the above description, an example in which the hand-movement interval is determined by calculation and an example in which the hand-movement interval is determined using the table of the delay adjustment setting 132 have been described, but these may be used in combination. For example, a minimum interval may be prescribed in the delay adjustment setting 132, and intervals relating to the remaining hand-movement timings may be determined by linearly dividing the interval into an appropriate number of portions according to the number of times of unexecuted operation.

Further, in the above description, the electronic timepiece 1 has been described as an example, but the drive control apparatus 10 may be mounted in an electronic device other than the electronic timepiece 1 that performs display using a hand that operates periodically at intervals shorter than one second. The seconds to be displayed need not be time of day and may be elapsed time based on an arbitrary timing. Further, the hand that performs sweep hand movement is not limited to the second hand 241. The hand may instead be another function hand that performs rotational operation at a cycle shorter than one second.

Further, in the above description, the storage 13 including a nonvolatile memory such as a flash memory has been described as an example of a computer-readable medium storing the program 131 relating to hand-movement control of the present disclosure, but the present disclosure is not limited thereto. As another computer-readable medium, another nonvolatile memory such as MRAM, or a removable storage medium such as a CD-ROM or a DVD disc, may be applied. Further, as a medium that provides data of the program according to the present disclosure via a communication line, a carrier wave is also applicable. In addition, the specific configurations, contents and procedures of the processing operations, and the like described in the above embodiment may be appropriately changed without departing from the spirit of the present disclosure. The scope of the present disclosure includes the scope of the invention described in the claims and equivalents thereof.

1. An electronic timepiece comprising a hand, a driver configured to cause the hand to perform rotational operation, and a controller configured to control an operation of the driver, wherein
the controller
causes, by the driver, for each synchronization time, the hand to perform rotational operation for a number of plurality of times of unit operation at an interval of a unit time obtained by dividing the synchronization time by the number of times of unit operation, and
in response to the interval of the rotational operation of the hand becoming greater than the unit time to cause a delay time during the rotational operation for the number of times of unit operation, the controller eliminates the delay time by setting, as respective intervals until at least two executions of unexecuted operation among a number of times of unexecuted operation before a first rotational operation in a next synchronization time, values obtained by distributing respective non-zero offset times corresponding to the delay time and adding the respective non-zero offset times to the unit time.

2. The electronic timepiece according to claim 1, wherein the offset times include both positive and negative values.

3. The electronic timepiece according to claim 2, wherein the offset times monotonically decrease from a positive time shorter than the delay time to a negative time.

4. The electronic timepiece according to claim 1, wherein the offset times are negative values.

5. The electronic timepiece according to claim 4, wherein the offset times asymptotically approach zero.

6. The electronic timepiece according to claim 4, wherein the offset times are fixed values.

7. The electronic timepiece according to claim 1, further comprising a storage configured to store, for each number of times of unexecuted operation, a variation pattern obtained by normalizing the offset times for the number of times of unexecuted operation, wherein
the controller sets the respective offset times for the number of times of unexecuted operation by multiplying an initial delay time when the delay time occurs by the respective normalized offset times included in the variation pattern.

8. The electronic timepiece according to claim 1, further comprising a storage configured to store setting values relating to intervals, wherein
in response to occurrence of the delay time, the controller reads out from the storage the setting values corresponding to the delay time and the number of times of unexecuted operation, and sets the respective offset times for the number of times of unexecuted operation.

9. A drive control method relating to an operation of a driver of an electronic timepiece that includes a hand and the driver configured to cause the hand to perform rotational operation, the method comprising:
causing, by the driver, for each synchronization time, the hand to perform rotational operation for a number of plurality of times of unit operation at an interval of a unit time obtained by dividing the synchronization time by the number of times of unit operation, and
in response to the interval of the rotational operation of the hand becoming greater than the unit time to cause a delay time during the rotational operation for the number of times of unit operation, eliminating the delay time by setting, as respective intervals until at least two executions of unexecuted operation among a number of times of unexecuted operation before a first rotational operation in a next synchronization time, values obtained by distributing respective non-zero offset times corresponding to the delay time and adding the respective non-zero offset times to the unit time.

10. The drive control method according to claim 9, wherein the offset times monotonically decrease from a positive time shorter than the delay time to a negative time.

11. The drive control method according to claim 9, wherein the offset times are negative values.

12. The drive control method according to claim 11, wherein the offset times asymptotically approach zero.

13. The drive control method according to claim 9, wherein
the electronic timepiece further includes a storage configured to store, for each number of times of unexecuted operation, a variation pattern obtained by normalizing the offset times for the number of times of unexecuted operation, and
the drive control method further comprises setting the respective offset times for the number of times of unexecuted operation by multiplying an initial delay time when the delay time occurs by the respective normalized offset times included in the variation pattern.

14. The drive control method according to claim 9, wherein
the electronic timepiece further includes a storage configured to store setting values relating to intervals, and
the drive control method further comprises, in response to occurrence of the delay time, reading out from the storage the setting values corresponding to the delay time and the number of times of unexecuted operation, and setting the respective offset times for the number of times of unexecuted operation.

15. A non-transitory computer-readable recording medium storing a program for a computer included in an electronic timepiece that includes a hand and a driver configured to cause the hand to perform rotational operation, the program causing the computer to execute:
causing, by the driver, for each synchronization time, the hand to perform rotational operation for a number of plurality of times of unit operation at an interval of a unit time obtained by dividing the synchronization time by the number of times of unit operation, and
in response to the interval of the rotational operation of the hand becoming greater than the unit time to cause a delay time during the rotational operation for the number of times of unit operation, eliminating the delay time by setting, as respective intervals until at least two executions of unexecuted operation among a number of times of unexecuted operation before a first rotational operation in a next synchronization time, values obtained by distributing respective non-zero offset times corresponding to the delay time and adding the respective non-zero offset times to the unit time.

16. The recording medium according to claim 15, wherein the offset times monotonically decrease from a positive time shorter than the delay time to a negative time.

17. The recording medium according to claim 15, wherein the offset times are negative values.

18. The recording medium according to claim 17, wherein the offset times asymptotically approach zero.

19. The recording medium according to claim 15, wherein
the electronic timepiece further includes a storage configured to store, for each number of times of unexecuted operation, a variation pattern obtained by normalizing the offset times for the number of times of unexecuted operation, and
the program causes the computer to further execute setting the respective offset times for the number of times of unexecuted operation by multiplying an initial delay time when the delay time occurs by the respective normalized offset times included in the variation pattern.

20. The recording medium according to claim 15, wherein
the electronic timepiece further includes a storage configured to store setting values relating to intervals, and
the program causes the computer to further execute, in response to occurrence of the delay time, reading out from the storage the setting values corresponding to the delay time and the number of times of unexecuted operation, and setting the respective offset times for the number of times of unexecuted operation.
